(19) United States
(12) Patent Application Publication
(10) Pub. No.: US 2009/0222879 A1
(43) Pub. Date: Sep. 3, 2009

(54) SUPER POLICY IN INFORMATION PROTECTION SYSTEMS

(75) Inventors: Gregory Kostal, Kirkland, WA (US); Rushmi U. Malaviarachchi, Redmond, WA (US); Scott C. Cottrille, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/041,444

(22) Filed: Mar. 3, 2008

(51) Int. Cl. G06F 21/00

(52) U.S. Cl. 726/1

(57) ABSTRACT

Providing access to information based on super policy. Information is associated with author policy expressing restrictions on use of the information The author policy is processed using super policy programmatic code to generate a composite policy. The composite policy includes a combination of the author policy and super policy applied by the super policy programmatic code, such that restrictions are added to or removed from the author policy to create the composite policy. A request for the information is evaluated. This includes evaluating information about the requester against the composite policy to determine if the requester is authorized to access the information. A determination is made that the requester is authorized to access the information based on the composite policy, where after the requester is authorized to access the information based on the composite policy, access is granted to the information to the requester.

### BACKGROUND

### Background and Relevant Art

Computers and computing systems have affected nearly every aspect of modern living. Computers are generally involved in work, recreation, healthcare, transportation, entertainment, household management, etc.

Many computer systems include information protection systems. Some information protection systems allow for defining usage policy that can be applied to information to protect it. The usage policy is enforced during consumption of the information. Typical usage policy may define access to the information, when the information may be accessed, what kinds of access may be granted to the information (e.g. read-only access, editing access, copying access, printing access, etc.). Typically, the usage policy is defined by an author of the information or an “owner” of the information, such as a corporation. However, it may be useful to change the usage policy at a consumption location where the information will be consumed. For example, information may be provided by one entity to an organization that will consume the information.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment disclosed herein is directed to a method practiced in a computing system. The method includes acts for providing access to information based on policy. The method includes receiving a request from a requester to access information. The information is associated with author policy expressing restrictions on use of the information by expressing at least one of who can use the information, how the information can be used, or what conditions apply to the use of the information. The author policy is processed using super policy to generate a composite policy. The composite policy includes a combination of the author policy and super policy applied by the super policy programmatic code, such that restrictions are added to or removed from the author policy to create the composite policy. The request is evaluated. This includes evaluating information about the requestor against the composite policy to determine if the requester is authorized to access the information. A determination is made that the requester is authorized to access the information based on the composite policy. As a result of determining that the requester is authorized to access the information based on the composite policy, access to the information is granted to the requester.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates application of author policy to information;

FIG. 1B illustrates application of author policy and super policy to information;

FIG. 1C illustrates one method of applying super policy to author policy to create composite policy;

FIG. 1D illustrates another method of applying super policy to author policy to create composite policy;

FIG. 2 illustrates a system including logging functionality; and

FIG. 3 illustrates a method of implementing super policy.

### DETAILED DESCRIPTION

Some embodiments described herein are directed to applying super policy along with author policy so as to change the restrictions on the use of information. For example, in some embodiments, super policy may be applied at an organization level so as to change restrictions on the use of information in a manner more suitable for the organization. Illustrating now an example of where this functionality may find utility, modern legal trends have required that computer stored information be available for discovery during litigation processes. A typical information content author is typically not able to specify usage restrictions that allow for the archival and/or access of the information in accordance with an organization's information retention policy. To facilitate compliance with the organization's information retention policy, super policy may be combined with author defined policy so as to grant additional access to archival and access systems associated with information retention policy compliance.

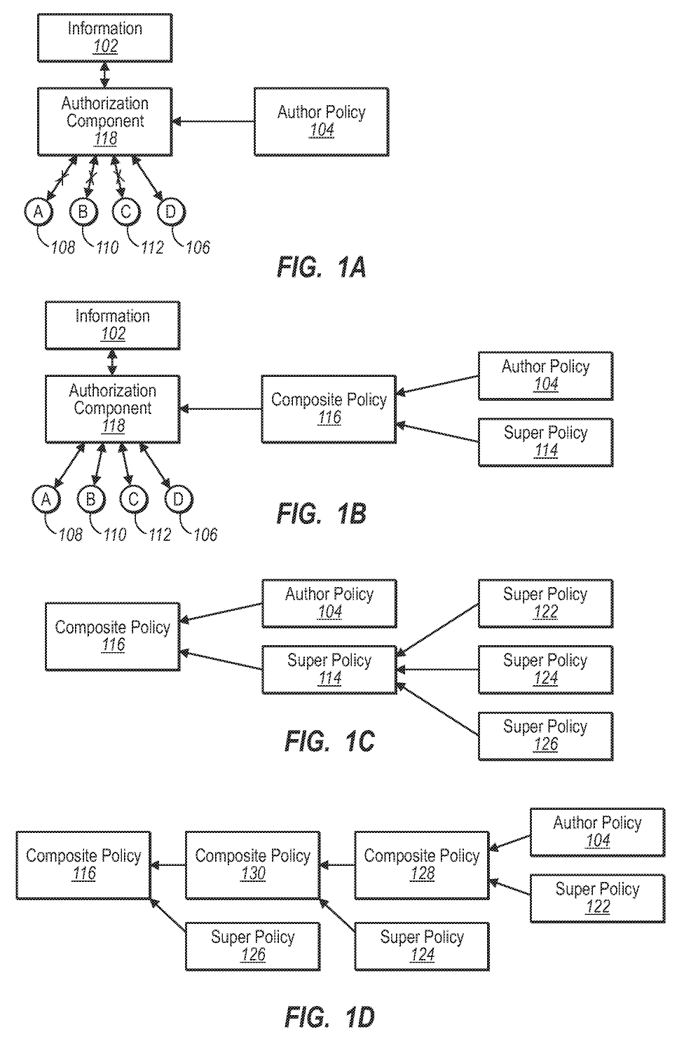

Reference is now made to FIG. 1A so as to facilitate the illustration of one embodiment as well as a number of alternative embodiments that maybe implemented within the scope of embodiments contemplated herein. FIG. 1A illustrates information 102. The information 102 is electronic content authored by a content author. The information 102 may be for example documents, spreadsheets, e-mail, database entries, multimedia content, or any other appropriate digital content. The information 102 may be stored on various computer storage devices including but not limited to volatile random access memory, static random access memory, flash media, computer hard drives, computer-readable optical media, etc. Author policy 104 may be applied to information 102 by a variety of entities, two typical examples being the content author or an automated agent running on behalf of the organization.

The author policy 104 specifies restrictions on the use of the information 102. For example, the author policy 104 may specify who can use the information 102, when the information 102 can be used, what kinds of activities can be performed on the information 102 (e.g. read, write, print, copy, delete etc.). Thus, the restrictions may specify identities and permissions.

As noted, the author policy 104 may specify who can use the information 102. This may be specified, for example, in the form of the individual identities, in the form of group identities, in the form of claims based identities, in the form of a role based identities, etc. Individual identities specify specific entities that are allowed or disallowed access to the information 102. Group identities specify groups of entities. Claims based identities specify restrictions based on a set of one or more validated claims presented by an entity (e.g. possessing a specific citizenship, having an office in a specific building, being of a certain age, etc.). Role based identities are specified based on an entity's role (e.g. manager, owner, auditor, compliance officer, etc.).

The author policy 104 may further specify how the information can be used. As discussed previously, such usage restrictions may specify read only, read and write, copy, share or forward, print, etc.

The author policy 104 may further specify conditions that must be satisfied to access the information 102. Such conditions may include time restrictions, including expiration of times or dates, ranges of times and dates etc. Additionally, conditions may be applied to authentication types presented. For example, for some information certain additional authentication such as smart card or biometric second factor authentication may be required. Additionally, the author policy 104 may express restrictions based on devices used to access the information 102. For example, the author policy 104 may restrict access from mobile phone devices, devices without appropriate security software installed, or other types of devices.

The author policy 104 may further contain restrictions based on the type of resource. For example, the author policy 104 may specify differing restrictions dependant on whether the information 102 resides in an e-mail, in a document, in a database entry, etc.

In the example illustrated in FIG. 1A, the author policy 104 specifies that an entity D 106 can access the information 102 and that entity A 108, entity B 110, and entity C 112, are restricted from accessing the information 102. In other embodiments, the author policy 104 may specify that only entity D 106 can access the information 102, implying that other entities, including entity A 108, entity B 110, and entity C 112, are restricted from accessing the information 102. Access restrictions may be enforced by an authorization component 118 which has access to the author policy 104. In information protected systems entities are not allowed to access the information 102 directly, but rather can access through an authorization component 118 which enforces information protection restrictions.

As noted previously, it may be important in the organization which includes entity A 108, entity B 110, and entity C 112, that these entities be allowed to access the information 102. For example, entities A 108, B 110, and C 112 may be associated with the information retention policies, virus scanning functionality, administrative user functionality, information transportation troubleshooting, etc. Thus, some embodiments described herein allow the application of super policy to allow access based on the needs of a particular organization.

Reference is now made to FIG. 1B which illustrates author policy 104 and a super policy 114. The author policy 104 and super policy 114 are combined into a composite policy 116. The composite policy 116 is then applied to the information 102 through the authorization component 118 as opposed to just applying the author policy 104. The composite policy 116 allows access to the information 102 by entity A 108, entity B 110, entity C 112 and entity D 106. While in the example illustrated in FIG. 1B unrestricted access is granted to each of the entities, other alternative embodiments may apply varying restrictions on the access granted to the entities. Examples of such restrictions are illustrated above in conjunction with the discussion of the restrictions applied based on the author policy 104. Further, it should be noted that in some embodiments the super policy 114 can cause the composite policy 116 to grant more restrictive or less restrictive access to entity D 106 than was granted by the author policy 104. For example, the author policy 104 may have granted unrestricted access to the information 102 to entity D 106. The super policy 114 may cause the composite policy 116 to restrict access to the information 102 to entity D 106 to allow access only during normal business hours. Alternatively, the author policy 104 may authorize the entity D 106 un-restricted read access to the information 102 while restricting entity D's ability to modify the information 102. The super policy 114 may cause the composite policy 116 to allow the entity D 106 un-restricted read and write access to the information 102.

Author policy 104 is typically expressed in a rule based fashion. For example, a text based document may specify information restrictions such who may access the information, how the information may be accessed, what information may be accessed etc. Super policy can be expressed in the same textual rule based fashion, or alternatively super policy can be expressed using logical algorithms and code implementing the policy as part of business logic or as general rules.

As noted above, super policy may add restrictions to existing author policy. Alternatively, super policy may remove restrictions from existing author policy.

Notably, super policy may be dynamic in that the policy may change depending on various conditions or states. Embodiments including dynamic super policy may be especially useful when the super policy is implemented as business logic code. Super policy may determine restrictions based on environmental conditions. For example organization business logic may detect certain agents on a network and may determine that it is unsafe to allow access to certain information. In another example, super policy logic may be able to detect a denial of service (DOS) attack and may choose to limit the type of access to certain information available within the organization. Additionally, super policy may determine information restrictions based on how an entity is attempting to access the information. For example, super policy may implement more restrictions when an entity attempts to access information through remote access, such as through a VPN, Web-based organization interface, etc.

Notably, super policy may be implemented in a number of different fashions. For example, FIG. 1C illustrates super policy 114 being a composite of super policy 122, super policy 124, and super policy 126. In the example illustrated super policy 122 includes functionality for authorizing entity A 108 (illustrated in FIG. 1B) to access the information 102. Super policy 124 includes functionality for authorizing access to entity B 110 (illustrated in FIG. 1B) to the information 102. Super policy 126 includes functionality for granting access to the entity C 112 (illustrated in FIG. 1B) to the information 102. In other examples, a single super policy module may include functionality for authorizing multiple entities. In the example illustrated in FIG. 1C logical code sections may be combined to form the super policy 114. The super policy 114 may be composed of logical code which can operate on the author policy 104 so as to create the composite policy 116.

FIG. 1D further illustrates another example of how super policy may be implemented. In the example illustrated author policy 104 is combined with super policy 122 to form a composite policy 128. Super policy 124 is combined with the composite policy 128 to form the composite policy 130. Super policy 126 is combined with the composite policy 130 to create the composite policy 116. In one example embodiment of the example illustrated in FIG. 1D the super policy 122 may comprise programmatic code that operates on the author policy 104 to add policy allowing entity A 108 (illustrated in FIG. 1B) to access the information 102. As noted previously the programmatic code of super policy 122 may also modify the author policy 104 to create more or less restrictive restrictions for the policy granting access to entity D 106 (illustrated in FIG. 1B). The composite policy 128 created by the programmatic code of super policy 122 operating on the author policy 104 may be operated on by programmatic code for super policy 124. This process may continue in a chained fashion as illustrated in FIG. 1D.

Notably the embodiments in FIG. 1C and FIG. 1D illustrate examples where different super policy is applied to create a composite policy 116. In some embodiments different super policy modules may be implemented by different entities or different portions of an organization, or by different organizations. Thus super policy can be used to stack additional policy restrictions on to information as information is distributed among different groups, entities, organizations, etc.

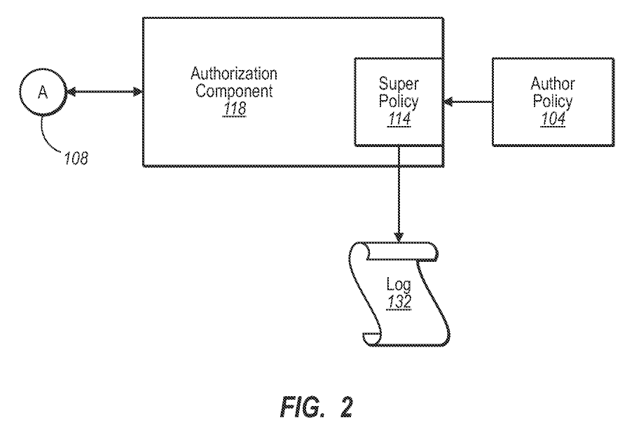

Super policy code may further include auditing and logging functionality. For example, and referring now to FIG. 2, the super policy 114 may be implemented as programmatic code which is tied to or which is part of the authorization component 118. Similarly the authorization component 118 and/or the super policy 114 may be programmatic code implemented as part of the business logic of an organization. The programmatic code of the authorization component 118 and/or the super policy 114 may be used to generate a log 132. In particular, the log 132 may be generated when super policy 114 is used to grant access to an entity such as the entity A 108. This allows for auditing functionality to be performed by an organization to determine when super policy has been used to grant access to data.

Additionally, embodiments may include functionality for implementing a user interface. For example, a graphical user interface may be implemented where the graphical user interfaces is tied to super policy programmatic code. One embodiment of the graphical user interface can be used to display the logging information 132. This allows an administrator to evaluate the manner in which access to information is being granted to different entities within the organization. Additionally, the graphical user interface may include functionality for allowing an administrator to configure super policy. For example, an administrator can provide information directing how policy is applied to information based on the super policy.

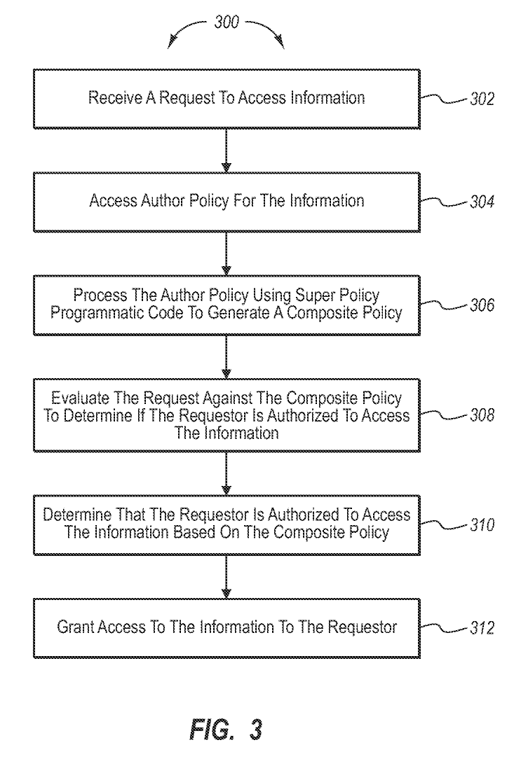

Referring now to FIG. 3, a method 300 is illustrated. The method may be practiced in a computing system. The method includes acts for providing access to information based on policy. The method includes receiving a request from a requester to access information (act 302). The information is associated with author policy expressing restrictions on use of the information by expressing at least one of who can use the information, how the information can be used, or what conditions apply to the use of the information.

The method 300 further includes accessing the author policy (act 304). The author policy is processed using super policy programmatic code to generate a composite policy (act 306). The composite policy includes a combination of the author policy and super policy applied by the super policy programmatic code. As such, restrictions are added to or removed from the author policy to create the composite policy. An Example of this is illustrated in FIG. 1B where author policy 104 is combined with super policy 114 to create composite policy 116.

The method 300 further includes evaluating the request against the composite policy to determine if the requester is authorized to access the information (act 308). For example, FIG. 1B illustrates an authorization component 118 that may be used to evaluate requests from entities A 108, B 110, C 112, and D 106.

The method 300 further includes determining that the requester is authorized to access the information based on the composite policy (act 310). For example, the authorization component 118 may determine that an entity requesting access to information 102 is authorized access the information 102 based on the composite policy 116 applied to the information 102.

As a result of determining that the requester is authorized to access the information based on the composite policy, access is granted to the information to the requester (act 312).

The method 300 may be practiced where the author policy is provided by the author of the information. For example, a content author may provide author policy 104 with information 102 to an organization. In some embodiments, the author policy is provided by an author of the information while the super policy programmatic code is provided by a consumer of the information, which is an entity distinct and separate from the author of the information. For example, the author policy 104 may be provided by an author who is separate from an organization that will consume the information 102. At the organization, super policy 114 may be applied to the information such that a composite policy 116 is created which is more suitable for the organization. The super policy 114 is provided by the organization as opposed to the author who provided the author policy 104. In fact, where the author is a distinct entity from the organization, the author may have no input or knowledge of the policy implemented by the super policy 114. Notably, embodiments may be implemented where the author policy is provided by an entity other than the author, such as the organization, a content management system, a central compliance officer within an organization etc.

The method 300 may be implemented where the super policy is defined through workflows. Workflows are programmatic code implemented using declarative programming languages as opposed to imperative programming languages. In declarative programming, a goal or function is defined and implemented by a framework whereas in imperative programming languages machine instructions define specific actions that should be taken without necessarily referencing the end result or goal. Notably, declarative programming languages do not necessarily include the specific machine instructions instructing the computing system how to achieve the defined goal. Rather, the specific instructions are provided by the framework which interprets the declared function or goal.

Embodiments of the method 300 may be implemented where processing the author policy using super policy programmatic code includes evaluating environmental conditions and adding or removing restrictions based on the environmental conditions. For example, environmental conditions may include health of a computer workstation, agents on a network, etc.

Similarly, embodiments of the method 300 may be practiced where processing the author policy using super policy programmatic code includes evaluating contextual information and adding or removing restrictions based on the contextual information. For example, contextual information may be evaluated where multiple pieces of content are related in some way, such as by linking a chart from a spreadsheet into a document or putting a number of files together in a content management system. If the author policies on those files are not synchronized, an accessor might encounter difficulty because they could access some of the files but not all of the files they needed. Super policy could sort that out by determining that access to a specific file should be granted to a given user because that user was accessing that file in relation to (or directly from) another file to which the user did have access.

The method 300 may be practiced where processing the author policy using super policy programmatic code includes evaluating organization business logic and adding or removing restrictions based on the organization business logic. For example, an organization may include business logic that controls how information is processed, archived, or otherwise handled. Super policy may be applied to ensure that the organization business logic is able to function appropriately.

Notably, some embodiments of the method 300 may be practiced where processing the author policy using super policy programmatic code includes using event driven programmatic modules to process the author policy. For example, embodiments may be implemented where an access request or archiving operation generates an event. The event may then be used to signal that super policy should be applied so as to be able to grant appropriate access to information to accomplish the access or archiving operations.

As illustrated by the example illustrated in FIGS. 1C and 1D, embodiments may be practiced where processing the author policy using super policy programmatic code comprises iteratively processing policy using a plurality of super policy programmatic code modules, wherein each programmatic code module is configured to add or remove restrictions. Notably, some embodiments where iteratively processing policy using a plurality of super policy programmatic code modules may include prioritization considerations as well. In particular, the order in which modules are applied may affect the restrictions existing in composite policy. Thus, ordering may be used to accomplish a desired composite policy result.

As noted previously, embodiments may include graphical user interface functionality for displaying information to administrators or users. For example, in one embodiment of the method 300, method includes providing an indication that access is being granted based on super policy. For example, when a user is granted access to Information, and the access is granted as a result of applying super policy, an indication may be made to the user so that the user is aware of how the access was granted to the user. In alternative embodiments, an indication can be provided to an author of the information that access is being granted based on super policy.

Because application of the super policy to the author policy results in composite policy that is different than the author policy, embodiments of the method 300 may further include providing an indication to a user (e.g. the recipient) indicating the policy in the composite policy. For example, a graphical user interface may be used to display details of the composite policy including restrictions implemented by the composite policy.

As noted above, the method 300 may be implemented such that the method further includes generating logging information indicating that access was granted to the requester based on application of super policy. For example, FIG. 2 illustrates an example where the authorization component 118 in the super policy component 114 may be used in conjunction to generate a log 132. The log 132 may include information defining when access was granted to an entity based on super policy 114. The log may include information such as what entity access was granted, when the access was granted, aspects of the super policy 114 that were used to grant the access, environmental conditions existing at the time the access was granted, etc.

Embodiments herein may comprise a special purpose or general-purpose computer including various computer hardware, as discussed in greater detail below.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing system, a method of providing access to information based on policy, the method comprising:
receiving a request from a requestor to access information, wherein the information is associated with author policy expressing restrictions on use of the information by expressing at least one of who can use the information, how the information can be used, or what conditions apply to the use of the information;
accessing the author policy;
processing the author policy using super policy programmatic code to generate a composite policy, the composite policy including a combination of the author policy and super policy applied by the super policy programmatic code, such that restrictions are added to or removed from the author policy to create the composite policy;
evaluating the request, including information about the requester, against the composite policy to determine if the requester is authorized to access the information;
determining that the requester is authorized to access the information based on the composite policy; and
as a result of determining that the requester is authorized to access the information based on the composite policy, granting access to the information to the requester.

2. The method of claim 1, wherein the author policy is provided by the author of the information.

3. The method of claim 1, wherein the super policy is defined in a same language as the author policy;

4. The method of claim 1, wherein the super policy is defined through workflows.

5. The method of claim 1, wherein the super policy is defined by an organization distributing the information.

6. The method of claim 1, further comprising generating logging information indicating that access was grated to the requester based on application of super policy.

7. The method of claim 1, wherein processing the author policy using super policy programmatic code comprises evaluating environmental conditions and adding or removing restrictions based on the environmental conditions.

8. The method of claim 1, wherein processing the author policy using super policy programmatic code comprises evaluating contextual information and adding or removing restrictions based on the contextual information.

9. The method of claim 1, wherein processing the author policy using super policy programmatic code comprises evaluating organization business logic and adding or removing restrictions based on the organization business logic.

10. The method of claim 1, wherein processing the author policy using super policy programmatic code comprises using event driven programmatic modules to process the author policy.

11. The method of claim 1, wherein the author policy is provided by an author of the information while the super policy programmatic code is provided by a consumer of the information, which is an entity distinct and separate from the author of the information.

12. The method of claim 1, wherein processing the author policy using super policy programmatic code comprises iteratively processing policy using a plurality of super policy programmatic code modules, wherein each programmatic code module is configured to add or remove restrictions.

13. The method of claim 12, further comprising prioritizing the super policy programmatic code modules prior to iteratively processing policy using the programmatic code modules.

14. The method of claim 1, wherein restrictions being added to or removed from the author policy comprises extending the validity time or removing the validity time.

15. The method of claim 1, wherein restrictions being added to or removed from the author policy comprises extending the activities that can be performed on the information.

16. The method of claim 1, further comprising providing an indication that access is being granted based on super policy.

17. The method of claim 1, further comprising providing an indication to a user indicating the policy in the composite policy.

18. In a computing system, a method of providing access to information based on policy, the method comprising:
displaying a user interface, the user interface configured to receive input from a user to define super policy for information,
accessing author policy, wherein the author policy is associated with the information, the author policy expressing restrictions on use of the information by expressing at least one of who can use the information, how the information can be used, or what conditions apply to the use of the information;
generating super policy programmatic code from the user input;
processing the author policy using the super policy programmatic code to generate a composite policy, the composite policy including a combination of the author policy and super policy applied by the super policy programmatic code, such that restrictions are added to or removed from the author policy to create the composite policy; and
using the composite policy to evaluate requests to access the information.

19. The method of claim 18, further comprising, indicating through the user interface all of the restrictions enforced by the composite policy.

20. In a computing environment, a physical computer readable medium comprising computer executable instructions that when executed by a processor are configured to cause the following:
receiving a request from a requestor to access information, wherein the information is associated with author policy expressing restrictions on use of the information by expressing at least one of who can use the information, how the information can be used, or what conditions apply to the use of the information;
accessing the author policy;
processing the author policy using super policy programmatic code to generate a composite policy, the composite policy including a combination of the author policy and super policy applied by the super policy programmatic code, such that restrictions are added to or removed from the author policy to create the composite policy;
evaluating the request, including information about the requester, against the composite policy to determine if the requester is authorized to access the information;
determining that the requester is authorized to access the information based on the composite policy; and
as a result of determining that the requester is authorized to access the information based on the composite policy, granting access to the information to the requester.
